(19) United States
(12) Patent Application Publication
(10) Pub. No.: US 2019/0043068 A1
(43) Pub. Date: Feb. 7, 2019

(54) VIRTUAL NET PROMOTER SCORE (VNPS) FOR CELLULAR OPERATORS

(71) Applicant: Continual Ltd., Caesarea (IL)

(72) Inventors: Eshai LIVNE, Karkur (IL); Assaf ALONI, Kadima (IL); Jose COHENCA, Natania (IL); Yossi BAR-YOSEF, Hod-HaSharon (IL); Hadas BEN AMI, Kadima (IL); Yizhar RONEN, Hod-HaSharon (IL)

(21) Appl. No.: 16/055,114

(22) Filed: Aug. 5, 2018

Related U.S. Application Data
(60) Provisional application No. 62/541,797, filed on Aug. 7, 2017.

(51) Int. Cl. G06Q 30/02; G06N 7/00; G06F 15/18

(52) U.S. Cl. CPC G06Q 30/0203; G06N 7/005; G06F 15/18; G06Q 30/0205; G06Q 30/0201

(57) ABSTRACT

A computer implemented method of predicting a rating score of a cellular service for a plurality of cellular subscribers, comprising obtaining one or more machine learning models trained with a plurality of feature vectors created for a subset of a plurality of cellular subscribers of a cellular operator participating in a survey to rate a cellular service provided by the cellular operator through a cellular network where each of the feature vectors is created by extracting a plurality of features of a respective cellular subscriber of the subset, each feature vector is associated with a rating score assigned by the respective cellular subscriber, predicting an estimated rating score of the cellular service for other cellular subscribers by applying the machine learning model(s) to the feature vector of extracted features of each of the other cellular subscribers and outputting the estimated rating score for each of the other cellular subscribers.

### RELATED APPLICATION

This application claims the benefit of priority under 35 USC § 119(e) of U.S. Provisional Patent Application No. 62/541,797 filed on Aug. 7, 2017, the contents of which are incorporated herein by reference in their entirety.

### FIELD AND BACKGROUND OF THE INVENTION

The present invention, in some embodiments thereof, relates to predicting a rating score of a cellular service and/or product for a plurality of cellular subscribers, and, more specifically, but not exclusively, to predicting a rating score of a cellular service and/or product for a plurality of cellular subscribers using one or more trained machine learning models.

Competition in the cellular services arena is constantly growing harder as multiple cellular operators offer cellular service(s) and/or product(s). In order to maintain and/or increase their market share, many of the cellular operators take considerable measures to monitor the satisfaction level of their cellular subscribers.

One of the common methods used to evaluate the satisfaction/dissatisfaction level of the cellular subscribers is conducting surveys, for example, Net Promoter Score (NPS) surveys in which target cellular subscribers are approached (surveyed) and requested to rate (assign a rating score) one or more services and/or products provided by the cellular operator.

### SUMMARY OF THE INVENTION

According to a first aspect of the present invention there is provided a computer implemented method of predicting a rating score of a cellular service for a plurality of cellular subscribers, comprising:

Obtaining one or more machine learning models trained with a plurality of feature vectors created for a subset of a plurality of cellular subscribers of a cellular operator participating in a survey to rate a cellular service provided by the cellular operator through a cellular network. Each of the plurality of feature vectors is created by extracting a plurality of features of a respective cellular subscriber of the subset. Each feature vector is associated with a rating score assigned by the respective cellular subscriber.

Predicting an estimated rating score of the cellular service for at least some of the plurality of cellular subscribers by applying the machine learning model(s) to the feature vector of extracted features of each of the at least some cellular subscribers.

Outputting the estimated rating score for each of the at least some cellular subscribers.

Automatically predicting the rating scores for the plurality of cellular subscribers may extend availability of the rating scores for large groups of cellular subscribers and optionally to the entire population of the cellular subscribers without actually conducting NPS surveys for these groups thus significantly reducing the required resources such as effort, time and/or cost. Moreover, since the rating scores prediction is automated, it may be conducted often, periodically and/or continuously to provide an accurate, up to date and possible real time reflection of the true satisfaction/dissatisfaction level of the cellular subscribers. Such automated, fast, economically superior rating score prediction methods, tools and/or systems providing up to date rating score for extremely large groups of cellular subscribers may allow the cellular operator to take measures to improve the quality of the provided service(s) and/or product(s) and thus reducing a detractor rate and significantly improving the reputation and brand strength of the cellular operator.

According to a second aspect of the present invention there is provided a system for predicting a rating score of a cellular product and/or service for a plurality of cellular subscribers, comprising one or more processors adapted to execute code, the code comprising:

Code instructions to obtain one or more machine learning models trained with a plurality of feature vectors created for a subset of a plurality of cellular subscribers of a cellular operator participating in a survey to rate a cellular service provided by the cellular operator through a cellular network. Each of the plurality of feature vectors is created by extracting a plurality of features of a respective cellular subscriber of the subset. Each feature vector is associated with a rating score assigned by the respective cellular subscriber.

Code instructions to predict an estimated rating score of the cellular service for at least some of the plurality of cellular subscribers by applying the machine learning model(s) to the feature vector of extracted features of each of the at least some cellular subscribers.

Code instructions to output the estimated rating score for each of the at least some cellular subscribers.

According to a third aspect of the present invention there is provided a software program product for predicting a rating score of a cellular product and/or service for a plurality of cellular subscribers, comprising:

A non-transitory computer readable storage medium.

First program instructions for obtaining one or more machine learning models trained with a plurality of feature vectors created for a subset of a plurality of cellular subscribers of a cellular operator participating in a survey to rate a cellular service provided by the cellular operator through a cellular network. Each of the plurality of feature vectors is created by extracting a plurality of features of a respective cellular subscriber of the subset. Each feature vector is associated with a rating score assigned by the respective cellular subscriber.

Second program instructions for predicting an estimated rating score of the cellular service for at least some of the plurality of cellular subscribers by applying the machine learning model(s) to the feature vector of extracted features of each of the at least some cellular subscribers.

Third program instructions for outputting the estimated rating score for each of the at least some cellular subscribers.

Wherein the first, second and third program instructions are executed by one or more processors from the non-transitory computer readable storage medium.

In a further implementation form of the first, second and/or third aspects, each of the plurality of cellular subscribers is a subscriber of the cellular operator and using one or more cellular device to connect to the cellular network. Each cellular subscriber may use one or more cellular devices to connect to the cellular network and consume the service(s) and/or product(s) offered by the cellular operator.

In a further implementation form of the first, second and/or third aspects, the plurality of features comprises one or more of: one or more personal features of each cellular subscriber and one or more Key Quality Indicator (KQI) features associated with each cellular subscriber. The one or more KQI features are indicative of a quality of a usage feature relating to each cellular subscriber. Collecting the personal and KQI features may allow accurately characterizing each of the cellular subscribers. This characterization may be later used to identify relations, correlations and/or the like between types of cellular subscribers.

In a further implementation form of the first, second and/or third aspects, one or more of the KQI features are obtained by analyzing one or more operational records of the cellular network collected for the cellular service. The one or more operational records provide information relating to one or more of: a cellular usage detail, a cellular billing detail. Obtaining the KQI features from operational records available from the cellular operator, the cellular service(s) and/or the cellular network may significantly simplify the automated operation of the rating score prediction, in particular for accessing the operational records to retrieve the KQI features.

In a further implementation form of the first, second and/or third aspects, one or more of the KQI features is obtained by analyzing data transmitted over the cellular network using application specific KQI information provided by one or more Deep Packet Inspection (DPI) tools. Characterization of the cellular subscribers may be significantly improved by getting improved accuracy KQI features, additional KQI features and/or KQI features specifically related to specific services and/or applications. Moreover, 3^{rd} party tools already available may be used to simplify design, deployment and/or assimilation of the automated rating score prediction methods, tools and/or systems.

In an optional implementation form of the first, second and/or third aspects, one or more of the plurality of features is normalized to generalize the plurality of feature vectors. Generalizing the features may allow for improving uniformity and/or normal distribution of the feature vectors.

In an optional implementation form of the first, second and/or third aspects, one or more dimensions of each feature vector are reduced using a Linear Discriminant Analysis (LDA). The dimensions reduction may improve discrimination in the feature vector(s)'s space.

In a further implementation form of the first, second and/or third aspects, the estimated rating score is associated with a prediction probability value. The probability score which is typically a product of the machine learning model(s) indicates a confidence level in the predicted rating score and may be used to improve accuracy of the predicted overall rating score, predicted NPS, predicted detractors, detractor scores and/or the like.

In an optional implementation form of the first, second and/or third aspects, the estimated rating score is predicted for the at least some cellular subscribers for a segment of the cellular service. The segment is a member of a group consisting of: a section of the cellular network, a certain geographical region, a certain geographical location, a certain segment of the at least some cellular subscribers, a certain type of the cellular service, and a certain cellular device type used by the at least some cellular subscribers. Segmenting the cellular network and predicting the rating scores on segment basis may allow identifying satisfaction/dissatisfaction for the segments and may significantly improve isolating detractor root cause according to the segments.

In an optional implementation form of the first, second and/or third aspects, a source cause of dissatisfaction is identified for one or more detractor subscribers of the at least some cellular subscribers. This may allow the cellular operator to easily identify possible source cause for satisfaction/dissatisfaction and potential detectors. Based on this, the cellular operator may take one or more actions, measures and/or the like to increase a satisfaction level among the detractors population of cellular subscribers.

In an optional implementation form of the first, second and/or third aspects, the estimated rating score is normalized according to a confidence value provided by the one or more machine learning model to avoid a false positive detection.

Normalizing the estimated rating score with the confidence level of the estimation may improve accuracy of the predicted overall rating score, predicted NPS, predicted detractors, detractor scores and/or the like.

In a further implementation form of the first, second and/or third aspects, the one or more machine learning models utilize one or more statistical probabilistic Gaussian Mixture Models (GMM). The GMM machine learning model is proved to be an efficient model for statistical estimations and predictions and may well serve the automated rating scores prediction methods, tools and/or systems.

In an optional implementation form of the first, second and/or third aspects, one or more of the machine learning models are trained with a plurality of other feature vectors created for one or more other subsets of the plurality of cellular subscribers participating in one or more other surveys. Every time a new survey is conducted, the results may be used to further train the machine learning model(s) thus improving their estimation and prediction accuracy.

In an optional implementation form of the first, second and/or third aspects, an alert is generated in case an aggregated value of the estimated rating score computed for the at least some cellular subscribers exceeds a predefined threshold. The cellular operator may set one or more predefined thresholds such that when crossed an alert may be generated in real time. Specifically such thresholds may be set to identify major detractor issues, trends and/or patterns. When the alert is received, the cellular operator may take one or more rapid actions, measures and/or the like to handle the identified issue, trend and/or pattern.

In an optional implementation form of the first, second and/or third aspects, the features and rating scores of the at least some cellular subscribers are analyzed to produce big data analytics to identify one or more rating pattern of the at least some cellular subscribers. The big data analytics may allow for easy identification of rating patterns, trends and/or fluctuations among the population of the cellular subscribers, isolation of potential issues to specific segments of the cellular service and/or formulating specific recommendations and/or actions for reducing the detractor score.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced

In the drawings:

FIG. 1 is a flowchart of an exemplary process of predicting a rating score of a cellular service for a plurality of cellular subscribers, according to some embodiments of the present invention;

FIG. 2 is a schematic illustration of an exemplary system for predicting a rating score of a cellular service for a plurality of cellular subscribers, according to some embodiments of the present invention;

FIG. 3 is a schematic illustration of an exemplary sequence of training machine learning models used for predicting a rating score of a cellular service for a plurality of cellular subscribers, according to some embodiments of the present invention;

FIG. 4 is a schematic illustration of an exemplary sequence of predicting a rating score of a cellular service for a plurality of cellular subscribers using trained machine learning models, according to some embodiments of the present invention;

FIG. 5 is a graph chart of an exemplary false positive prediction rate with respect to number of potential detractor cellular subscribers detected using trained machine learning model(s), according to some embodiments of the present invention;

FIG. 6 is a screenshot of an exemplary VNPS prediction application presenting a high level overview of an exemplary detractors group, according to some embodiments of the present invention;

FIG. 7 is a screenshot of an exemplary VNPS prediction application presenting a Low Quality Calls and Dropped Calls for an exemplary detractors group, according to some embodiments of the present invention.

FIG. 8 is a screenshot of an exemplary VNPS prediction application presenting a Low Quality Calls and Dropped Calls per cellular node (cell) for an exemplary detractors group, according to some embodiments of the present invention;

FIG. 9, which is a screenshot of an exemplary VNPS prediction application presenting a heat-map highlighting cellular nodes (cells) which contribute for an exemplary detractors group, according to some embodiments of the present invention; and

FIG. 10, which is a screenshot of an exemplary VNPS prediction application presenting distribution of a cellular device model type used by an exemplary detractors group, according to some embodiments of the present invention.

### DESCRIPTION OF SPECIFIC EMBODIMENTS OF THE INVENTION

The present invention, in some embodiments thereof, relates to predicting a rating score of a cellular service and/or product for a plurality of cellular subscribers, and, more specifically, but not exclusively, to predicting a rating score of a cellular service and/or product for a plurality of cellular subscribers using one or more trained machine learning models.

According to some embodiments of the present invention, there are provided methods, systems and computer program products for predicting a rating score, in particular an NPS score and more particularly a detractor score of a cellular service and/or product for large groups of cellular subscribers using one or more machine learning models trained with survey data collected for significantly small subsets of the overall population of cellular subscribers.

This process may be referred to as predicting a Virtual NPS (VNPS) which is in practice an NPS estimation for large groups of the plurality of cellular subscribers predicted without actually conducting a survey over the cellular subscribers of these groups.

In essence, the machine learning model(s) may be trained to learn of relations between features (i.e. personal and/or technical service usage attributes, characteristics, etc.) of cellular subscribers of the subsets and rating score information obtained during one or more surveys targeting the subset(s) for rating a quality of one or more cellular services and/or products provided by the cellular operator. The trained machine learning model(s) may then be applied to features of the cellular subscribers of the group(s) to predict an estimated rating score for the group(s) of cellular subscribers (not participating in the surveys) according to the learned relations.

In the first phase which is a training phase, the machine learning model(s), for example, a Gaussian Mixture Model (GMM), a Neural Network model and/or the like may be trained using sample data collected during the survey(s) for rating a quality of the service(s) and/or products provided by the cellular operator. The survey(s) comprise approaching the subset(s) of cellular subscribers and collecting rating scores assigned by each of the cellular subscribers of the subset(s) for the service(s) and/or product(s).

Each of the cellular subscribers of the subset(s) may be associated with a plurality of features, including personal features and/or technical service usage features. The personal features (personal information) may include personal attributes, characteristics and/or parameters of the respective cellular subscriber, for example, age, gender, residence area, subscription plan, typical usage pattern(s), payment method, account tenure, account spend, churn risk score, recent customer care complaints and/or the like. Such personal features may be extracted from information obtained from one or more sources and/or records, for example, a Customer Relations Management (CRM) system of the cellular operator and/or the like.

The technical service usage features may include technical attributes, characteristics and/or parameters of the respective cellular subscriber, in particular of his service usage and may be expressed through Key Quality Indicators (KQI) features which may be indicative of a quality of the service used and rated by the subset of cellular subscribers. The KQI features may be extracted (obtained) from one or more operational records of the cellular network and/or of the cellular operator.

The extracted features (both personal features and KQI features) are used to create a plurality of feature vectors each associated with a respective one of the cellular subscribers of the subset. Each of the feature vectors is naturally associated with the rating score assigned by the respective cellular subscriber of the subset during the survey(s) for rating the service(s) and/or product(s).

Optionally, while creating the feature vectors, one or more of the extracted features are normalized in order maintain normally distributed feature vectors.

Optionally, in order to simplify and/or to improve discrimination in the feature vector(s)'s space, a dimension reduction is applied to one or more of the feature vectors using one or more techniques, methods and/or algorithms as known in the art, for example, Linear Discriminant Analysis (LDA) and/or the like.

Using the plurality of feature vectors created for the cellular subscribers of the subset, the machine learning model(s) is created and/or trained such that the machine learning model(s) is able to classify, associate and/or identify the rating score assigned by each of the cellular subscribers of the subset(s) to the service(s) and/or product(s) with the feature vector of the respective cellular subscriber.

In the second phase which is a prediction phase, the machine learning model(s) is used to predict an estimated rating score for one or more groups of cellular subscribers comprising at least some of the overall cellular subscribers, in particular other cellular subscribers who did not participate in the survey(s).

A feature vector is created for each of the cellular subscribers of the group(s) similarly to the way it is done for the cellular subscribers of the subset during the training phase. The machine learning model(s) is then applied to the feature vectors of the cellular subscribers of the group(s) to predict the estimated rating score for each of the cellular subscribers of the group(s). For the estimated rating score of each of the cellular subscribers of the group(s), the machine learning model(s) may typically provide a prediction probability value (score) which may be indicative of the confidence (certainty) level of the estimated rating score in a scale of true estimation versus a false estimation.

The estimated rating scores may be further used to evaluate each of the cellular subscribers of the group(s) as a promoter, a detractor and/or a neutral cellular subscriber. Moreover, the estimated rating scores of the cellular subscribers may be aggregated to provide an overall rating score, trend and/or pattern, for example, the VNPS score, a detractor score and/or the like.

In case another one or more surveys are conducted among subsets (same or other) of the cellular subscribers for rating the service(s) and/or product(s), the machine learning model(s) may be updated with the survey information collected through these additional survey(s).

Optionally, the estimated rating score is normalized using the associated probability value.

The estimated rating scores, the VNPS score, the estimated detractor score and/or the like may be output, typically provided to the cellular operator providing the service(s) and/or product(s) for which the estimated rating score is predicted. The cellular operator may use the provided rating scores, the VNPS score and/or the estimated detractor score to take one or more actions, for example, a corrective action, a preventive action and/or the like to improve the VNPS score, in particular the estimated detractor score. One or more additional prediction cycles may be conducted following the application of the action(s) to evaluate the effect and/or success of the action(s).

Optionally, the estimated rating score, VNPS score and/or detractor score may be predicted for one or more segments of the cellular service, for example, a section/portion of the cellular network, a certain geographical region, a certain geographical location, a certain segment of the cellular subscribers, a certain service type (e.g. a video application, a voice application, etc.), a certain cellular device model and/or the like.

Optionally, an alert may be generated in case the aggregated value of the estimated rating score of the group of cellular subscribers exceeds a predefined threshold.

Optionally, big data analytics are applied for analyzing the KQI features coupled with the predicted rating score in order to identify one or more rating patterns of the cellular subscribers. The patterns may be further analyzed to provide the cellular operator insights with respect to the detraction level of the cellular subscribers using the service(s) and/or product(s).

Predicting the estimated rating scores, the VNPS score and/or the detractor score using the trained machine learning model(s) may present significant advantages.

Typically, current methods for obtaining the NPS score use survey information. The operation of conducting these surveys, collecting the survey information and analyzing the surveys information may consume considerable resources, for example, effort, time, cost and/or the like. Moreover such surveys are often challenged with a low response rate by the cellular subscribers. Therefore only a small sample of the cellular subscribers may be surveyed at each time. Due to this “under-sampling” approach, the surveyed set of cellular subscribers may not accurately reflect the true satisfaction/dissatisfaction level of the whole cellular subscribers set and may not provide reliable insights to problems that exist with delivery of the service(s) and/or product(s).

This limitation may be further emphasized by the fact that the entire population of cellular subscribers may be huge due to the rapid increase in cellular traffic, devices and/or services, for example, due to the spreading of the Internet of Things (IoT) and/or connected cars. Moreover, due to the complexity and low response, such surveys may not be conducted very often thus leading to further limitations in reflecting the true satisfaction/dissatisfaction level of the whole cellular subscribers set. Furthermore, the described limitations of the existing methods may prevent isolating source cause(s) for low satisfaction level to specific segments of the cellular service.

Using the VNPS approach in which the rating scores, the VNPS and/or the detractor score are predicted automatically may significantly improve over the limitations of the existing methods.

First, the rating scores, the VNPS and/or the detractor score may be extended for large groups of cellular subscribers and optionally to the entire population of the cellular subscribers without actually conducting NPS surveys for these groups thus significantly reducing the required resources such as effort, time and/or cost.

Moreover, since the VNPS prediction is automated, it may be conducted often, periodically and/or continuously to provide an accurate, up to date and possible real time reflection of the true satisfaction/dissatisfaction level of the cellular subscribers.

Furthermore, applying the KQI features and the big data analytics may allow for easy identification of rating patterns, trends and/or fluctuations among the population of the cellular subscribers, isolation of potential issues to specific segments of the cellular service and/or formulating specific recommendations and/or actions for reducing the detractor score.

Altogether through the evident advantages of the VNPS approach, the cellular operator may be able to take measures to improve the quality of the provided service(s) and/or product(s) and thus reducing the detractor rate and significantly improving its reputation and brand strength.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s).

In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

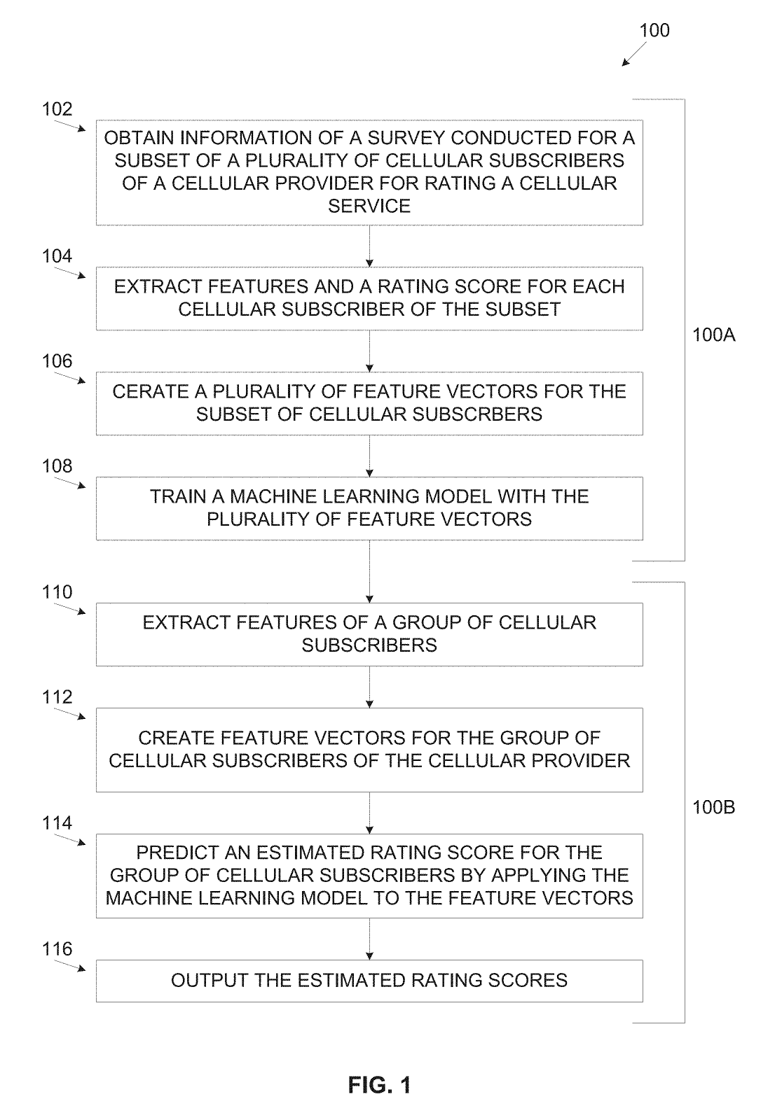

Referring now to the drawings, FIG. 1 is a flowchart of an exemplary process of predicting a rating score of a cellular service for a plurality of cellular subscribers, according to some embodiments of the present invention. An exemplary process 100 may be executed to predict a rating score of one or more services and/or products provided by a cellular operator through a cellular network for a plurality of cellular subscribers using one or more cellular devices (e.g. a cellular phone, a tablet, an IoT device, etc.) to connect to the cellular network. The process 100 is based on conducting one or more surveys in which one or more subsets (typically significantly small) of the cellular subscribers participate to rate a quality of the cellular service(s) and/or product(s).

The rating scores may be further aggregated to obtain an aggregated value, for example, an NPS. One or more machine learning models may be trained with the surveys information to learn the relations between the features (personal and/or technical service usage attributes, characteristics, parameters, etc.) of the subset(s) of cellular subscribers and the rating score information obtained for these subset(s) during the survey(s). The trained machine learning models may be used to predict the rating score of at least some of the other cellular subscribers for the service(s) and/or product(s), in particular, cellular subscribers who did not participate in the survey(s) according to the learned relations.

The estimated rating scores may be further used to evaluate each of the other cellular subscribers as a promoter, a detractor and/or a neutral. This process may be referred to as a VNPS since the other cellular subscribers are not actually surveyed but rather the rating score of these other cellular subscriber is predicted and may be aggregated to produce the VNPS score and/or a detractor score. The process 100 is composed of two phases, a training phase 100A and a prediction phase 100B.

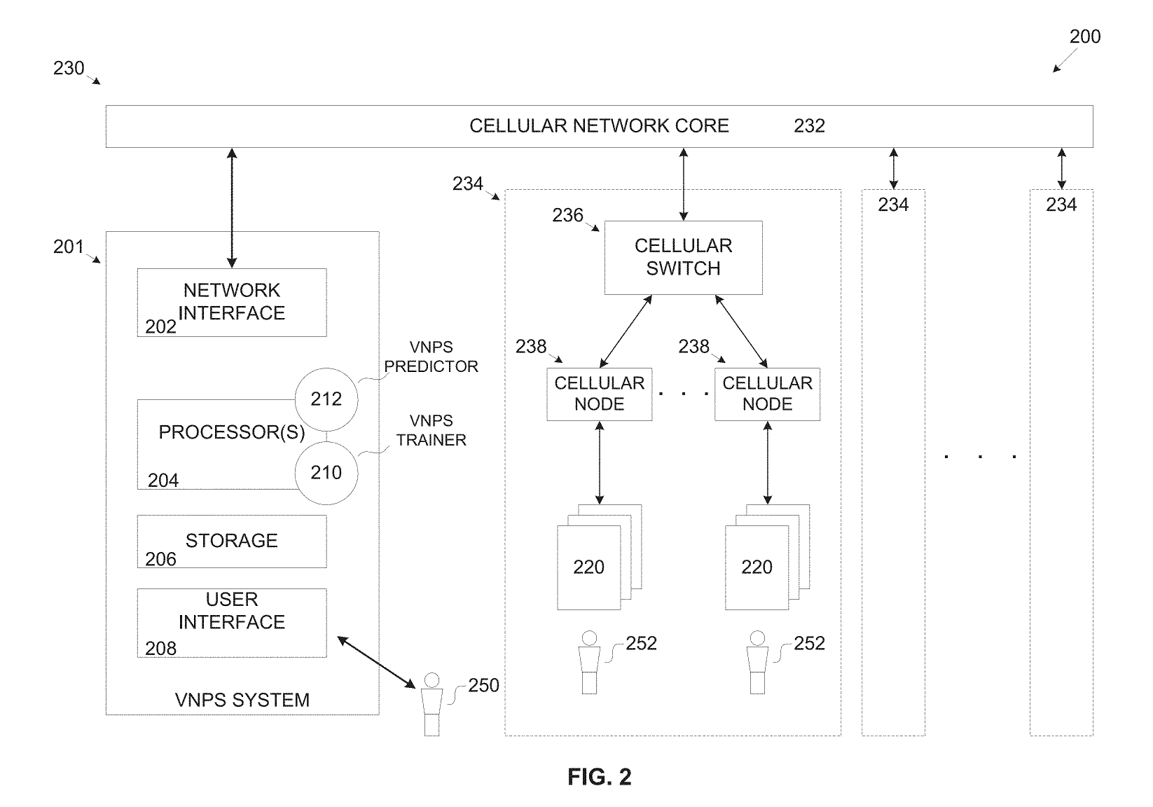

Reference is also made to FIG. 2, which is a schematic illustration of an exemplary system for predicting a rating score of a cellular service for a plurality of cellular subscribers, according to some embodiments of the present invention. An exemplary system 200 for executing a process such as the process 100 may comprise an exemplary cellular network 240 may be used by one or more service providers to provide cellular services to a plurality of cellular subscribers (users) 252 using one or more cellular device 220, for example, a cellular phone, a tablet, a laptop, an IoT device and/or the like.

The cellular network 240 may be typically constructed of a cellular network core 232 and comprise of one or more network sections, for example, a Radio Access Network (RAN) 234 each including one or more Radio Network Controllers (RNC) connecting to one or more elements of the cellular network core 232, for example, a circuit switch, a packet switch and/or the like at one end. On the other end the cellular switch 236 connects to one or more cells 238, for example, a Base Station (BS), a node-B, an e-Node-B, a cellular antennas and/or the like on the other end. Each of the cells 238 may serve at least some of the plurality of cellular subscribers 252 using the cellular device(s) 220 connected to the respective cell 238.

The cellular network core 232 (through the switches) may further provide access to one or more services and/or systems, for example, an Operational Support System (OSS), a telecommunications mediation system and/or the like which may provide information relating to the to the cellular subscribers 252, for example, operational technical information, billing information and/or the like. In particular, the cellular network core 232 may provide access to one or more records, for example, a Call Detail Records (CDR), a Charging Data Record (CDR), a billing record, an operational log record and/or the like.

The system 200 further includes a VNPS system 201, for example, a server, a processing node, a cluster of processing nodes and/or the like comprising a network interface 202 for connecting to the cellular network 230, a processor(s) 204 and storage 206. The processor(s) 204, homogenous or heterogeneous, may include one or more processors arranged for parallel processing, as clusters and/or as one or more multi core processor(s). The storage 206 may include one or more non-transitory persistent storage devices, for example, a hard drive, a Flash array and/or the like. The storage 206 may further comprise one or more network storage devices, for example, a storage server, a network accessible storage (NAS), a network drive, and/or the like. The storage 206 may also include one or more volatile devices, for example, a Random Access Memory (RAM) component and/or the like.

The storage 206 may store one or more software modules, for example, an Operating System (OS), an application, a tool, an agent, a service, a script and/or the like each comprising a plurality of program instructions that may be executed by the processor(s) 204 from the storage 206. The processor(s) 204 may execute a VNPS trainer 210 for training the machine learning model(s) which may comprise one or more models, for example, a Gaussian Mixture Model (GMM) and/or the like. The processor(s) 204 may also execute a VNPS predictor 212 for predicting an estimated rating score for a group comprising at least some of the plurality cellular subscribers 252 using the machine learning model(s). Optionally, the VNPS trainer 210 and the VNPS predictor 212 are implemented as a single integrated software package which may optionally include the trained machine learning model(s) as well.

Optionally, the VNPS system 201 is utilized through one or more remote platforms, for example, a remote server, a cloud computing platform, such as, for example, Amazon Web Service (AWS), Google Cloud, Microsoft Azure and/or the like. Additionally, and/or alternatively, the VNPS trainer 210 and/or the VNPS predictor 212 may be implemented as one or more remote services, a remote service, a cloud service, Software as a Service (SaaS), a Platform as a Service (PaaS) and/or the like.

Optionally, the VNPS system 201 includes a user interface 208 for interacting with one or more users 250, for example, an Information Technology (IT) officer, an administrator, an operator and/or the like. The user interface 208 may include one or more human-machine interfaces, for example, a keyboard, a pointing device, a touch pad, a display, a touch screen, an audio interface and/or the like for interacting with the user(s) 250. For example, the user interface 208 may be used to present a display to the user(s) 250, for example, a Graphic User Interface (GUI) utilized through one or more of the human-machine interfaces. Naturally, in case the monitoring system 201 is implemented through the remote platform(s) and/or the remote service(s), the monitoring system 201 may be accessible from one or more local client terminals, for example, a mobile device, a computer, a laptop, a server, a client terminal and/or the like using one or more access agents, for example, a web browser, a proprietary agent/application of the remote service and/or the like.

As shown at 102, the training phase 102 of the process 100 starts with the VNPS trainer 210 obtaining survey information collected through one of more surveys for rating a quality of one or more service(s) and/or product(s) offered and provided by the cellular operator. The survey(s) is typically conducted over a subset of cellular subscribers out of the overall cellular subscribers 252. The subset may typically include a relatively very small number of cellular subscribers 252. The survey information includes a rating score for the surveyed service(s) and/or product(s) assigned (awarded) by each of the surveyed cellular subscribers 252 of the subset. For example, for NPS surveys, the rating score may typically be on a scale of 0-10 where 0 indicates poor quality of the service(s) and/or product(s) and 10 indicates excellent quality of the service(s) and/or product(s).

Each of the cellular subscribers 252 of the subset may be further identified as a promoter, a detractor and/or a neutral (passive) and assigned with a survey tag accordingly. For example, assuming a rating scale of 0-10 for the rated service(s) and/or product(s), a promoter cellular subscriber may be associated with rating scores of 9-10, a detractor cellular subscriber may be associated with rating scores of 0-6 and a neutral (passive) cellular subscriber may be associated with rating scores of 7-8. A promoter cellular subscriber may be highly satisfied from the service(s) and/or product(s), he is likely to be a repeat customer and is likely to recommend the service(s) and/or product(s) to other potential cellular subscribers (customers). The detractor cellular subscriber may not be satisfied with the service(s) and/or product(s) and is not likely to purchase (subscribe) to the service(s) and/or product(s) again and is not likely to recommend the service(s) and/or product(s) to other potential cellular subscribers.

The detractor cellular subscriber may further spread negative impressions about the cellular operator, the service(s) and/or the product(s) and may thus hurt the reputation of the cellular operator. The neutral cellular subscriber may be somewhat satisfied with the service(s) and/or product(s) but may easily switch to a competitor's offering if given the opportunity. The neutral cellular subscriber is not likely to spread negative impressions about the cellular operator, the service(s) and/or the product(s) but is also not likely to promote them.

As shown at 104, the VNPS trainer 210 may extract one or more features of each of the surveyed cellular subscribers 252 of the subset. The features may include attributes and/or characteristics of the cellular subscriber and includes at least some personal features (personal information) of the cellular subscribers 252 of the subset and one or more technical KQI features of the cellular subscribers 252 of the subset which may each be indicative of a quality of the service used and rated by the cellular subscribers 252 of the subset.

In particular, in order to accurately associate the features with the results of the survey(s), the VNPS trainer 210 extracts the features of the cellular subscribers 252 of the subset which are relevant to the survey with respect to time and location, for example, a predefined time period preceding the time of the survey, a predefined time period during the time of the survey, a location of each of the cellular subscribers 252 of the subset prior to the time of the survey, a location of each of the cellular subscribers 252 of the subset during the time of the survey and/or the like.

The personal features (personal information) information may identify attributes, characteristics and/or parameters associated with each of the cellular subscribers 252 and may include, for example, age, gender, residence area, subscription plan (e.g. mobile, converged, etc.), typical usage pattern(s) (e.g. voice, data, certain application(s), etc.), payment method (e.g. prepaid, postpaid, etc.), account tenure, account spend, churn risk score (calculated based on history of the respective cellular subscriber 252), recent customer care complaints and/or the like. The VNPS trainer 210 may obtain the personal features from one or more sources and/or records, for example, a Customer Relations Management (CRM) system of the cellular operator.

The KQI features may include one or more indicator values of the service(s) and/or product(s) for each of the cellular subscribers 252 of the subset and may be associated with one or more of the service(s), for example, a voice service, a messaging service, a data service and/or the like. The KQI features may include, for example:

For voice service(s)—call drop events/rate, call setup failure events/rate, low quality call events/rate and/or the like.

For data service(s)—disconnection events/rate, setup failure events/rate, duration on lower grade protocols and/or infrastructure (e.g. 2G node, 3G node, etc.), CDR events count, average traffic volume, cross cluster or tech toggling events/rate, average throughput and/or the like.

The VNPS trainer 210 may further collect and/or identify the KQI features per specific application(s) (e.g. Facebook, YouTube, etc.) used by the cellular subscriber(s) 252, for example, average throughput per application, average buffering time per application, number of retry attempts per application and/or the like.

The VNPS trainer 210 may obtain the KQI features from one or more operational sources and/or records, for example, log records of the cellular network and/or of the cellular operator such as, for example, the CDRs available from the cellular network core 232, for example, from the OSS service(s), from the telecommunication mediation system(s) and/or the like. The VNPS trainer 210 may also obtain the KQI features from logging services and/or records available in the cellular network core 232, available from the cellular operator and/or the like. The CDRs are typically captured pre-meditation at their raw state, including non-billable events such as zero duration calls and zero volume data sessions.

Typically the CDR records (files) stream is forked to a dedicated file directory in an online manner, i.e. every batch of records that is propagated from one of the cellular network elements, for example, the cellular switch 236 to a meditation system is copied to the file directory, from which the VNPS trainer 210 may obtain and/or copy the files.

The VNPS trainer 210 may further use one or more Deep Packet Inspection (DPI) tools providing quality measures to obtain the KQI features for the cellular subscriber(s) 252The quality measures provided by DPI tool(s) may include, for example, use of specific application(s) such as, for example, YouTube, Facebook, Amazon music and/or the like for the cellular subscribers 252. The quality measures provided by DPI tool(s) may further include the use per application type, for example, video streaming, audio streaming, file upload/download and/or the like for the cellular subscribers 252.

Optionally, the VNPS trainer 210 normalizes one or more of the extracted features for one or more of the cellular subscribers 252 of the subset, in order to simplify, generalize and/or orthogonalize the feature(s) for the plurality of the cellular subscribers 252. For example, the gender feature (gender tag) may be transformed to a numerical feature and further normalized such that a male cellular subscriber 252 may be assigned a value of −1 for example, a female cellular subscriber 252 may be assigned a value of 1 and an unknown gender of a cellular subscriber 252 may be assigned with a value of 0. In another example, the age feature may be normalized to have a standard-normal distribution (with a mean value equaling zero, and a standard deviation of 1). Other attributes, such as “plan type”, may be transformed into a set of binary features (with a “one-hot” architecture, meaning that a specific “plan-type” gets a ‘1’ value respectively, while the others are set ‘0’ or ‘−1’).

As shown at 106, the VNPS trainer 210 creates a feature vector for each of the cellular subscribers 252 of the subset from the features extracted for the respective one of the cellular subscribers 252 of the subset. Each of the feature vectors is associated with the rating score assigned by the respective cellular subscribers 252 to the service(s) and/or product(s) for which the survey(s) was conducted. Optionally, each of the feature vectors is associated with the survey tag assigned to the respective cellular subscriber 252.

Optionally, the VNPS trainer 210 reduces dimensions of the feature vectors created for one or more of the cellular subscribers 252 of the subset in order to simplify complexity of the feature vectors such that the use of the feature vectors may be more efficient and less complex. The VNPS trainer 210 may use one or more techniques, methods and/or algorithms as known in the art for reducing the feature vectors dimensions, for example, the LDA and/or the like. Dimensionality reduction of the features space may serve several purposes, for example:

Reducing complexity of the model, for example, reducing the number of parameters for training, alleviating overfitting affects, reducing the computational load and hence the required computation resources.

Feature orthogonalization (de-correlation) which may support implementing simpler classification models.

Dimension reduction with discriminative transformations, for example, the LDA aims to achieve better discrimination between different classes in the reduced feature space, which may improve the overall classification accuracy.

As shown at 108, the VNPS trainer 210 uses the feature vectors created for the cellular subscribers 252 of the subset to train one or more machine learning models. The machine learning model(s) may utilize one or more models as known in the art, for example, a GMM a Neural Network and/or the like. In one example, the VNPS trainer 210 may create and train three machine learning models:

A Universal Background Model (UBM) (e.g. GMM) trained with all the feature vectors of the cellular subscribers 252 of the subset pooled together.

A detractor model (e.g. GMM) trained by adapting the UBM parameters to the feature vectors associated with detractor cellular subscribers of the subset.

A promoter model (e.g. GMM) trained by adapting the UBM parameters to the feature vectors associated with promoter cellular subscribers of the subset.

A neutral model (e.g. GMM) trained by adapting the UBM parameters to the feature vectors associated with neutral cellular subscribers of the subset.

In case another one or more surveys are conducted over additional subsets of the cellular subscribers 252 for the same service(s) and/or product(s), the VNPS trainer 210 may repeat the training phase 100A with the feature vectors and rating scores data obtained from the another survey(s) to enhance the machine learning model(s).

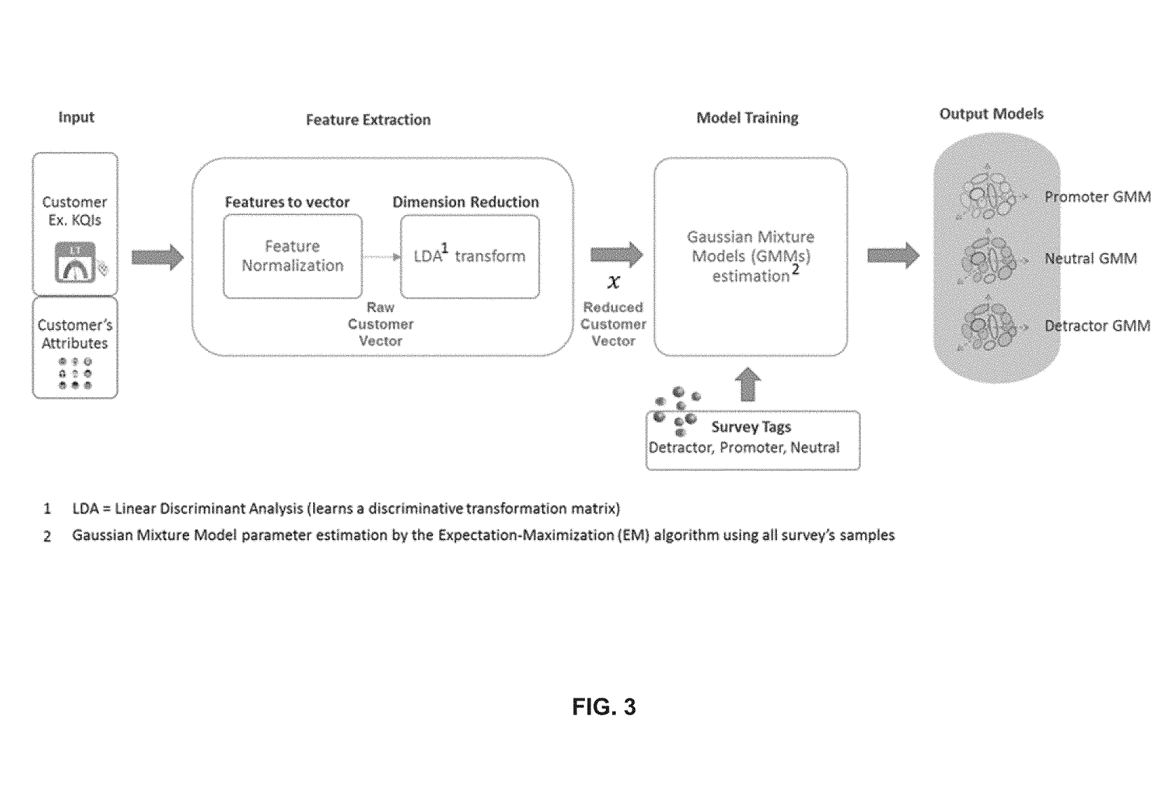

Reference is now made to FIG. 3, which is a schematic illustration of an exemplary sequence of training machine learning models used for predicting a rating score of a cellular service for a plurality of cellular subscribers, according to some embodiments of the present invention.

As discussed for the training phase 100A, a VNPS trainer such as the VNPS trainer 210 may obtain survey information collected through one or more surveys for one of more subsets of cellular subscribers such as the cellular subscribers 252. The VNPS trainer 210 may then extract the features for each of the cellular subscribers 252 of the subset(s) and create feature vectors for each of the cellular subscribers 252 of the subset(s). As discussed in step 104, the VNPS trainer 210 may optionally normalize one or more of the features while creating the feature vectors. Each of the feature vectors is associated with the rating score assigned to the surveyed service(s) and/or product(s) by the respective cellular subscriber 252 of the subset(s). As discussed in step 106, the VNPS trainer 210 may optionally reduce the dimensions of the feature vectors using one or more techniques, for example, the LDA.

The VNPS trainer 210 then uses the feature vectors to train one or more machine learning models, for example, a GMM, such as, for example, a promoter model (GMM), a neutral model (GMM) and a detractor model (GMM). The VNPS trainer 210 uses the survey tags associated with each of the feature vectors to identify the promoter cellular subscribers of the subset(s), the neutral cellular subscribers of the subset(s) and the detractor cellular subscribers of the subset(s). Using the tags the VNPS trainer 210 may properly classify the cellular subscribers 252 of the subset(s) to create and train the promoter model, the neutral model and the detractor model accordingly.

Reference is made once again to FIG. 1.

As shown at 110, the prediction phase 100B starts with the VNPS predictor 212 extracting features of one or more groups comprising at least some of the cellular subscribers 252, in particular cellular subscribers 252 who are not part of the subset, i.e. cellular subscribers 252 who did not participate in the survey(s). The group(s) may typically be a very large, in particular with respect to the size of the subset(s) and in some embodiments may include all of the cellular subscribers 252.

The VNPS predictor 212 may extract the features from network activity of the group of the cellular subscribers 252, in particular usage information of the group of the cellular subscribers 252 using one or more of the service(s) and/or product(s). The VNPS predictor 212 may obtain the usage information and extract the features, i.e. the personal features and the KQI feature(s) for the group of cellular subscribers 252 similarly to the way the VNPS trainer 210 extracted the features for the subset of cellular subscribers 252 as described in phase 104. Optionally, the VNPS predictor 212 may normalize one or more of the features as described for the VNPS trainer 210 in phase 104.

As shown in 112, the VNPS predictor 212 creates a feature vector for each of the group of cellular subscribers 252 from the features extracted for the respective one of the group of cellular subscribers 252. Optionally, the VNPS trainer 210 reduces dimensions of the feature vectors similarly to the way the VNPS trainer 210 reduced the dimensions of the feature vectors created for the subset of cellular subscribers 252 as described in phase 106.

As shown at 114, the VNPS predictor 212 applies the trained machine learning model(s), for example, the GMM, the Neural Network and/or the like to each of the feature vectors to predict an estimated rating score for the respective cellular subscriber 252 of the group of cellular subscribers 252. The estimated rating score indicates the rating score the respective cellular subscriber 252 of the group of cellular subscribers 252 (who did not participate in the survey(s)) is estimated to assign (award) the service(s) and/or product(s) that were addressed in the survey(s).

The trained machine learning model(s) may further provide a prediction probability value (score) associated with the estimated rating score. The prediction probability value indicates the level of confidence of the estimated rating score which may be used, for example, to avoid and/or reduce false alarms. The VNPS predictor 212 may further use the machine learning model(s) to tag each of the cellular subscribers 252 of the group as a promoter, a detractor and/or a passive cellular subscriber according to the estimated rating score computed by the machine learning model(s) for the respective cellular subscriber 252. The tag assigned to each of the group of cellular subscribers 252 may also be associated with a prediction probability value (score) that indicates the level of confidence of the assigned tag.

As shown at 116, the VNPS predictor 212 may output the estimated rating score for each of the cellular subscribers 252 in the group. The VNPS predictor 212 may also output the tag assigned to each of the group of cellular subscribers 252. Optionally, the VNPS predictor 212 normalizes the estimated rating score and/or the tag estimated for each of the group of the cellular subscribers 252 using the prediction probability values assigned by the machine learning model(s) to the estimated rating score and/or the tag accordingly.

The VNPS predictor 212 may further output an aggregated value of VNPS indicating an aggregated rating score, rating trend and/or rating pattern of the group of the cellular subscribers 252. For example, the VNPS predictor 212 may apply the formula expressed in equation 1 below to calculate a raw detractor score for the group of cellular subscribers 252 using the promoter model, the detractor model and the neutral model.

raw detector score=log P(x|Detractor Model)−1/2 log P(x|Promoter Model)−1/2 log P(x|Neutral Model) Equation 1

The VNPS predictor 212 may further normalize the aggregated value using the prediction probability values assigned by the machine learning model(s) to the rating score and/or tag of each of the group of cellular subscribers 252. For example, the VNPS predictor 212 may normalize the detractor score using the prediction probability values provided by the machine learning models, i.e. the detractor model, the promoter model and the neutral model for the estimated rating scores computed by the respective machine learning model.

Optionally, the VNPS predictor 212 stores previous estimated rating scores for one or more of the cellular subscribers 252. The VNPS predictor 212 may output and/or provide such history information.

Optionally, the VNPS predictor 212 may predict the estimated rating score for the group of cellular subscribers 252 for one or more segments of the cellular service, for example, a section of the cellular network, a certain cellular cell, a certain cellular cluster (e.g. an RNC, a TAC, a RAC, etc.), a certain geographical region, a certain geographical location (e.g. a certain road, a certain neighborhood, etc.), a certain segment of the cellular subscribers (e.g. a certain age range, a certain gender, etc.), a certain application type (e.g. a video application, a voice application, etc.), a certain cellular device model used by the group of cellular subscribers 252 and/or the like.

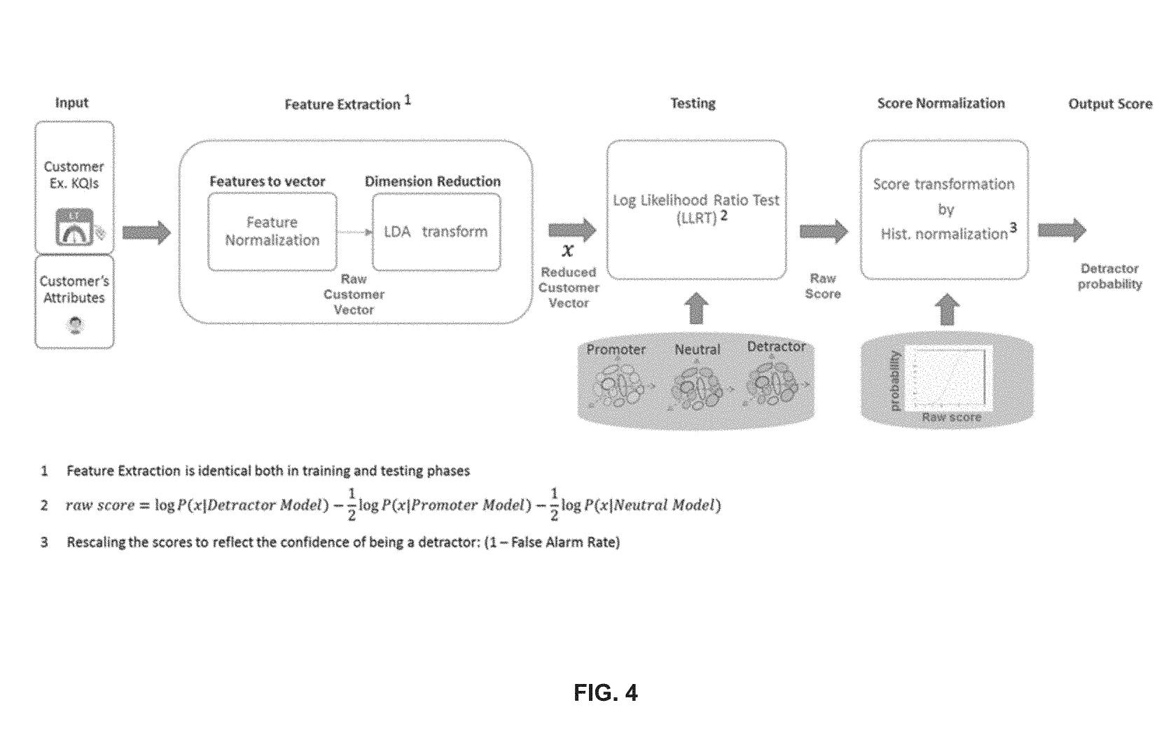

Reference is now made to FIG. 4, which is a schematic illustration of an exemplary sequence of predicting a rating score of a cellular service for a plurality of cellular subscribers using trained machine learning models, according to some embodiments of the present invention. As discussed for the prediction phase 100B, a VNPS predictor such as the VNPS predictor 212 may use the trained machine learning model(s) to predict the estimated rating score for a group and optionally all of a plurality of cellular subscribers such as the cellular subscribers 252. The VNPS predictor 212 may extract the features for each of the group cellular subscribers 252 and create feature vectors for each of the group.

As discussed in step 110, the VNPS predictor 212 may optionally normalize one or more of the features while creating the feature vectors. As discussed in step 112, the VNPS predictor 212 may optionally reduce the dimensions of the feature vectors using one or more techniques, for example, the LDA. The VNPS predictor 212 may then apply the trained machine learning model(s), for example, the promoter model (GMM), the neutral model (GMM) and/or the detractor model (GMM) to the feature vectors of the group of cellular subscribers 252 to predict the estimated rating score and/or tag for the service(s) and/or product(s) for each of the group. As described in step 116, the VNPS predictor 212 may normalize the estimated rating score and/or tag as well as the aggregated value computed for the entire group of cellular subscribers 252.

The VNPS predictor 212 may further generate an alert in case the aggregated value computed for the group of cellular subscribers 252 exceeds a predefined threshold. The alert may be directed to one or more of the users 250 and/or to one or more automated systems, for example, an operational system of the cellular operator, a CRM system of the cellular operator, a marketing system of the cellular operator and/or the like.

Optionally, the VNPS predictor 212 analyzes the KQI features of one or more of the group of cellular subscribers 252 in order to identify and/or infer one or more dissatisfaction source causes for one or more detractor cellular subscribers detected in the group. In particular, based on the analysis and the VNPS predictor 212 may identify whether the identified dissatisfaction source cause(s) is related, for example, to a technical issue, a customer service and/or pricing issue (CRM issue) and/or the like.

The VNPS predictor 212 may therefore provide the cellular operator accurate data regarding the dissatisfaction source cause(s) experienced by the detractor cellular subscribers detected in the group. In other words, VNPS predictor 212 may indicate whether the source of predicted dissatisfaction is rooted at the technical service of the cellular network and/or service or caused by a different aspect of the cellular operator service and/or pricing.

While the VNPS predictor 212 may not predict an exact detraction cause for CRM issues (i.e. not the operational/technical service of the cellular network, the VNPS predictor 212 may accurately distinguish between the operational/technical service issues and the CRM related issues. Within the predicted detractor group, the set of possible causes for each cellular subscriber 252 may be ranked with a probability score to indicate the impact of the respective cause on the overall detraction-prediction relating to a certain cellular subscriber 252 estimated as detractor). Based on the prediction and estimation of the VNPS predictor 212, the cellular service operator may be alerted to identify the source cause for dissatisfaction when the corresponding probability score exceeds a pre-defined threshold.

Based on the type of the identified dissatisfaction source cause(s) and the rating patterns detected by the VNPS predictor 212, the cellular operator may take one or more actions to overcome the dissatisfaction source cause(s) in order to reduce the number of detractor cellular subscribers. Reducing the population of detractor cellular subscribers may naturally increase the NPS score for the cellular operator as well as for the service(s) and/or product(s) and hence improve the reputation and potential commercial benefits of the cellular operator.

This data may enable the mobile network operator to apply one or more corrective actions to address the detraction problem, i.e. the dissatisfaction source cause(s) across its population of cellular subscribers 252. Furthermore, effect and/or success of these corrective actions may also be evaluated based on predictions of the population of detractor cellular subscribers performed after applying the corrective actions.

For example, assuming the identified dissatisfaction source cause(s) relates to a technical issue, the VNPS predictor 212 may advise the cellular operator to direct the issue to an engineering and/or operational teams, while in case the identified dissatisfaction source cause(s) relates to a specific device model issue, the VNPS predictor 212 may advise the cellular operator to refrain from offering that model.

Since the prediction machine learning model(s) is based on features of two types, network experience (delivered by the monitored KQIs) and personal features, the machine learning model(s) may provide additional grades on the influence of the network experience compared to the personal (CRM) profile. Hence, each predicted detractor cellular subscriber may be provided with a “probable direction” for solving the dissatisfaction source cause(s) (technical or marketing/customer care related).

The process 100 may be conducted periodically and optionally continuously to provide updated and accurate estimated rating scores, VNPS scores and/or detractor scores.

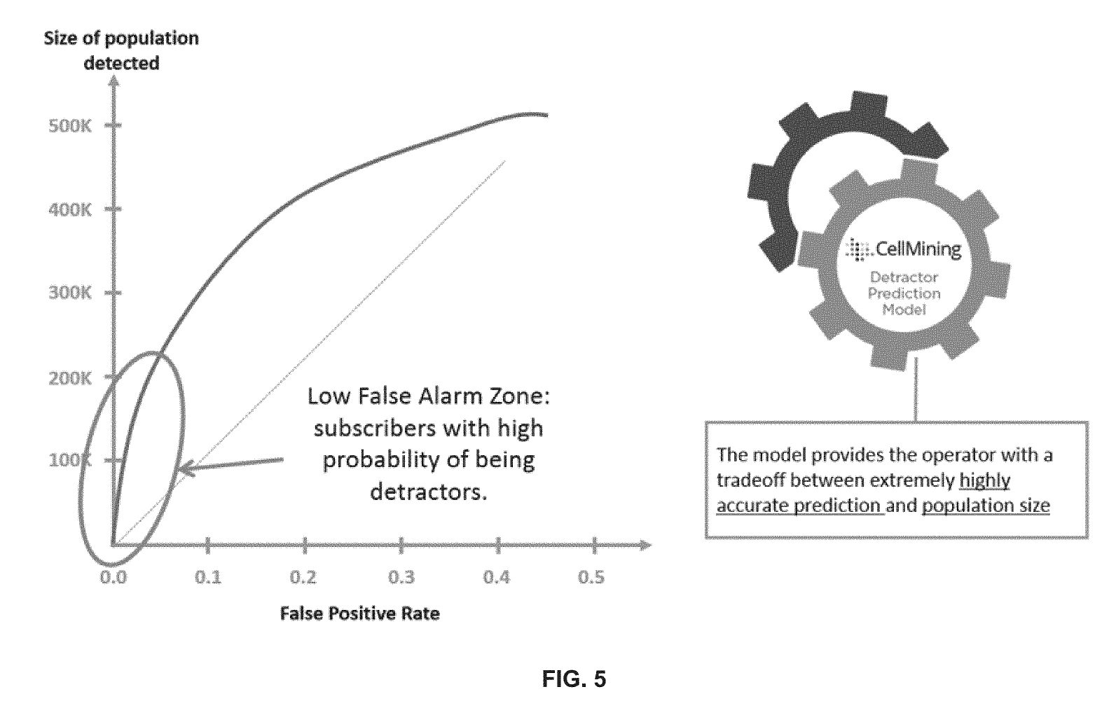

Reference is now made to FIG. 5, which is a graph chart of an exemplary false positive prediction rate with respect to number of potential detractor cellular subscribers detected using trained machine learning model(s), according to some embodiments of the present invention. The detractor prediction provided by a VNPS predictor such as the VNPS predictor 212 may introduce a tradeoff between the false-positive rate of the potential detractor cellular subscribers out of an overall population of cellular subscribers such as the cellular subscribers 252 with respect to the overall potential detractor cellular subscribers identified by the VNPS predictor 212.

The graph presented in FIG. 5 expresses the false positive precision, i.e. the level of confidence as expressed by the prediction probability value (score) provided by the machine learning model(s) with respect to the overall number of potential detractor cellular subscribers detected by the VNPS predictor 212. As evident a smaller number of detractor cellular subscribers may be identified with high certainty (probability) that they are indeed detractor cellular subscribers.

However, the larger the number of cellular subscribers 252 that are detected by the VNPS predictor 212 as potential detractor cellular subscribers, the level of certainty is continuously falling, i.e. the potential for false positive detection of a non-detractor cellular subscriber as a detractor cellular subscriber increases. Selection of the detractor population size may therefore be done according to the use made with the detractor prediction information and/or according to the (business) application of the detraction prediction. For example, cellular network optimization may require high precision of the detractor cellular subscriber population and may be satisfied with a representative sample of the predicted detractor cellular subscribers who use service(s), the cells of the cellular network 250 and/or the like.

Such an application may therefore select a group of only detractor cellular subscribers who are predicted to be detractors with a high certainty. Such a group may typically be small compared to the overall population of detected detractor cellular subscribers. In another example, marketing campaigns may be tolerant to higher false positive rates while benefitting from a larger target population of detected detractor cellular subscribers.

The VNPS predictor 212 may further provide big data analytics which are generated by analyzing the KQI features in conjunctions with the estimated prediction scores, in particular, the VNPS score and the detractor score. The VNPS predictor 212 may analyze the collected features and the estimated rating scores to produce big data analytics that may identify one or more patterns, trends and/or dissatisfaction source cause(s) of the detractor cellular subscribers detected in the population of the cellular subscribers 252.

For example, the VNPS predictor 212 may produce big data analytics to rank one or more serving cells such as the cells 238 according to their contribution to the population of the detractor cellular subscribers. The VNPS predictor 212 may estimate the contribution based on analysis of the KQI features associated with each of the ranked cells 238, i.e. the KQI features extracted for detractor cellular subscribers typically using the respective cell 238. For example, the VNPS predictor 212 may analyze the number of detractor cellular subscribers using the respective cell 238 together with the prediction probability value assigned to each estimated rating score to rank the respective cell 238 accordingly. The VNPS predictor 212 may further identify regional cell-site clusters presenting a high concentration of cells 238 ranked with high VNPS scores (i.e. highly contributing to the detractor population).

In another example, the VNPS predictor 212 may produce big data analytics to rank one or more cellular device models used by the detractor cellular subscribers according to their contribution to the population of the detractor cellular subscribers. The VNPS predictor 212 may analyze the KQI features associated with each cellular device model, i.e. the KQI features extracted for detractor cellular subscribers using the respective cellular device model. For example, the VNPS predictor 212 may analyze the number of detractor cellular subscribers using the respective cellular device model together with the prediction probability value assigned to each estimated rating score to rank the respective cellular device model accordingly.

Furthermore, the VNPS predictor 212 may automatically group together predicted detractor cellular subscribers with a probability value (score) above a predefined threshold, for example, 95% certainty (i.e. high probability value). The VNPS predictor 212 may update the detractors group following every training run (i.e. the process 100A) of the machine learning model(s). The VNPS predictor 212 V-NPS also maintains a prediction probability score per subscriber, including the history of predictions.

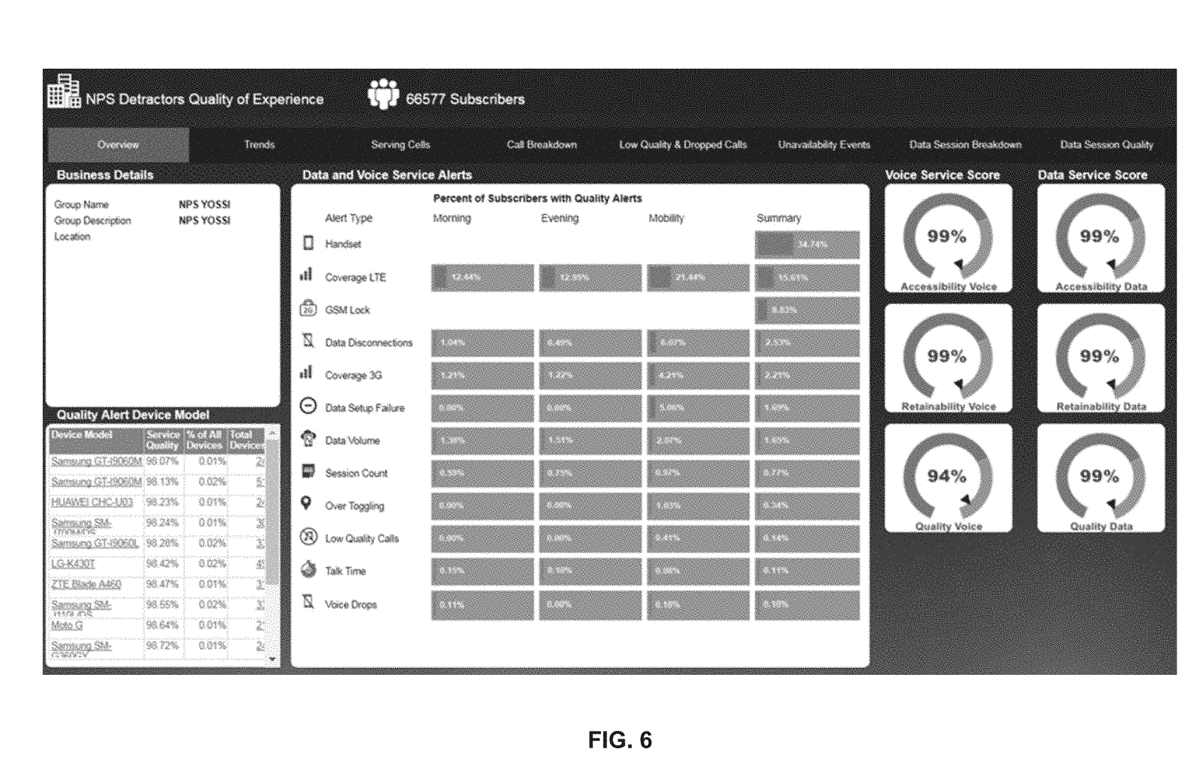

Reference is now made to FIG. 6, which is a screenshot of an exemplary VNPS prediction application presenting an exemplary detractors group, according to some embodiments of the present invention. A screenshot of an exemplary VNPS predictor such as the VNPS predictor 212 presents an exemplary group of detractor cellular subscribers detected in a population of cellular subscribers such as the cellular subscribers 252. The screenshot sums up the major KQI features of a cellular network service as experienced by the group of detractor cellular subscribers.

The screenshot further presents the rate of the population of detractor cellular subscribers which their KQI features values and distribution across serving cells such as the cells 238 meets a certain predefined criteria (threshold) that may trigger a service quality alert. From the screenshot which is a high level overview screen, one or more users, for example, a quality analyst, a network optimization expert and/or the like may drill down in to the details of the KQI features distribution, for example, across the population of detractor cellular subscribers and/or cells 238 for each of the KQI features.

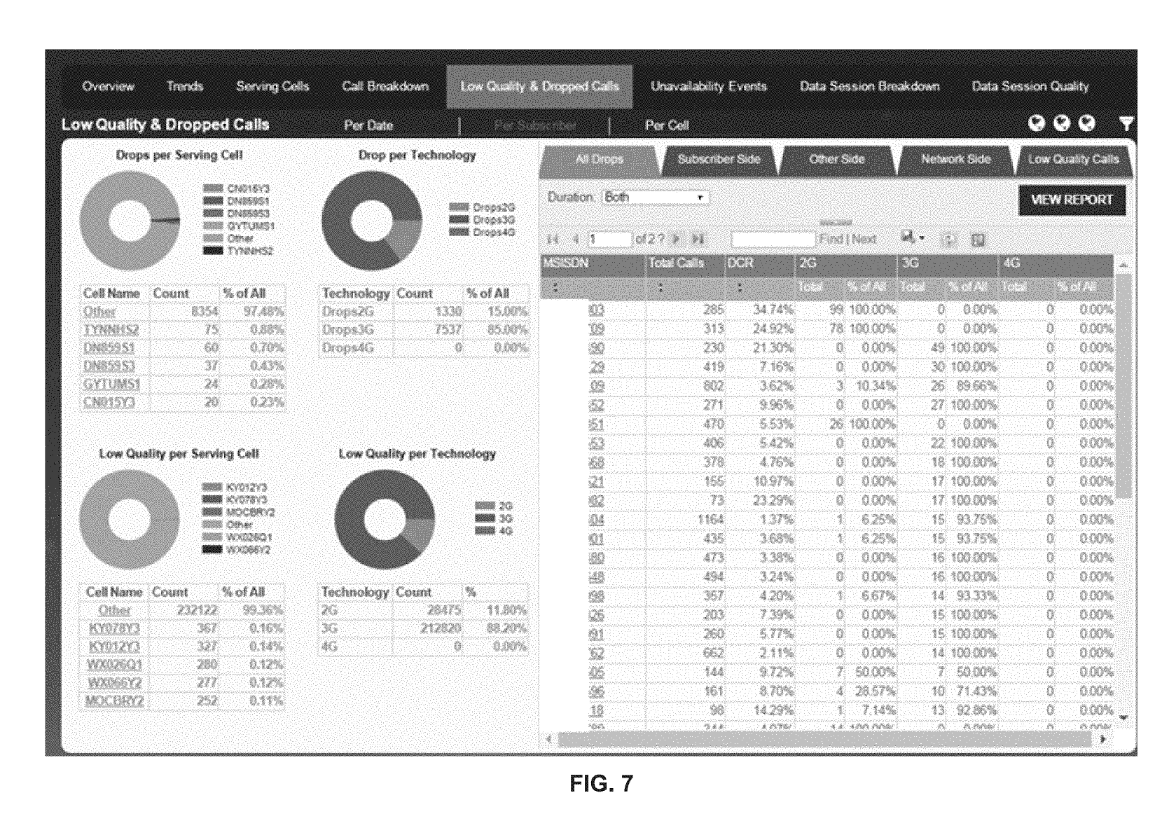

Reference is now made to FIG. 7, which is a screenshot of an exemplary VNPS prediction application presenting a Low Quality Calls and Dropped Calls for an exemplary detractors group, according to some embodiments of the present invention. A screenshot of an exemplary VNPS predictor such as the VNPS predictor 212 presents Low Quality Calls and Dropped Calls KQI features for a group of detractor cellular subscribers detected in a population of cellular subscribers such as the cellular subscribers 252. By default, this screenshot presents a detailed view of the top X detractor subscribers who experience the highest count or percent of the selected KQI. Naturally, Low Quality Calls and Dropped Calls KQI features are only part of the overall KQI features used, analyzed and/or assessed by the VNPS predictor 212.

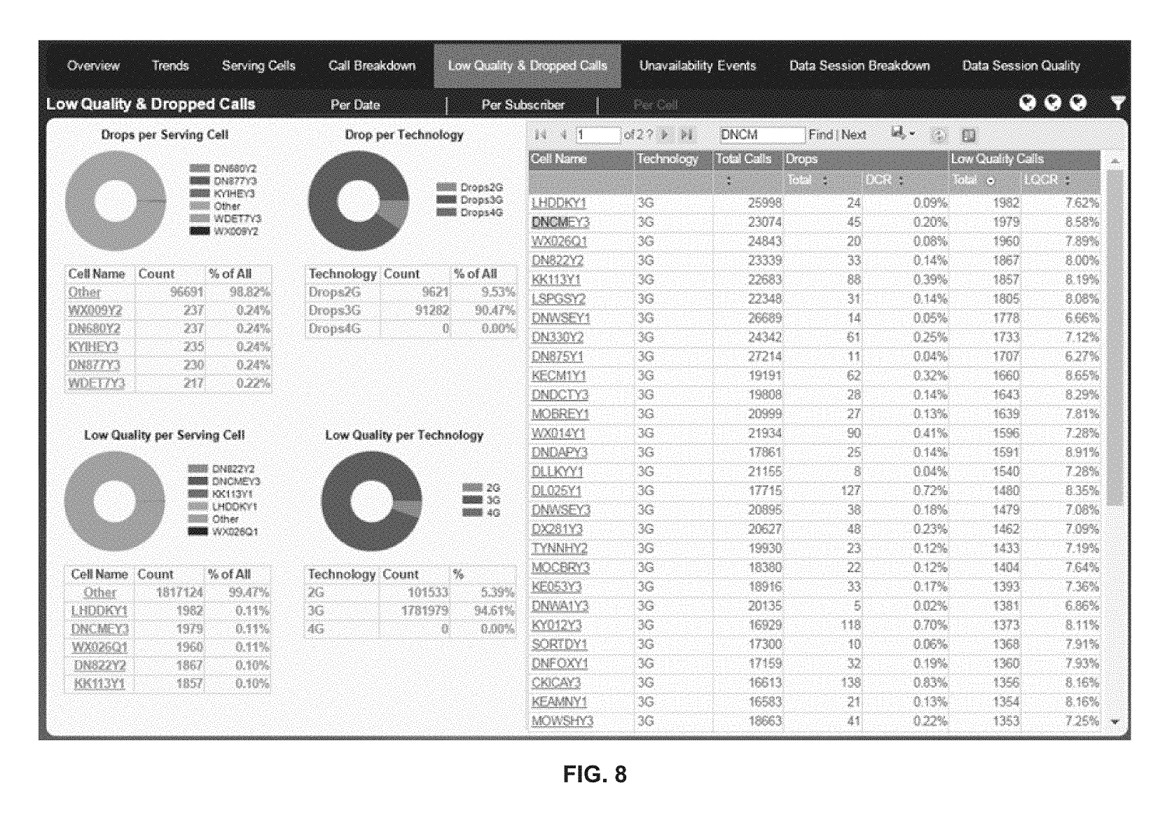

Reference is now made to FIG. 8, which is a screenshot of an exemplary VNPS prediction application presenting a Low Quality Calls and Dropped Calls per cell for an exemplary detractors group, according to some embodiments of the present invention. A screenshot of an exemplary VNPS predictor such as the VNPS predictor 212 presents Low Quality Calls and Dropped Calls KQI features for a group of detractor cellular subscribers detected in a population of cellular subscribers such as the cellular subscribers 252. The Low Quality Calls and Dropped Calls KQI features are presented according to their distribution across a plurality of cells such as 238. By default, this screenshot presents a detailed view of the top X cells who contribute the highest count or percent of the selected KQI to detractor cellular subscribers of the group.

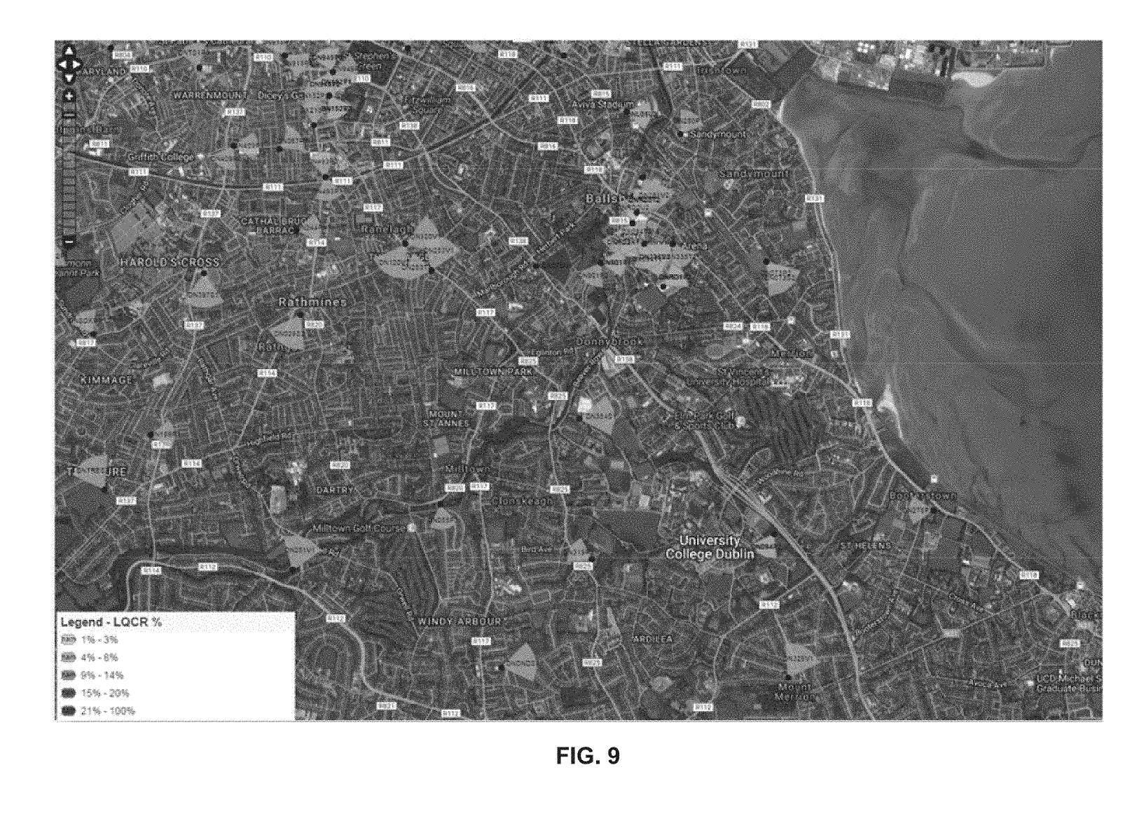

Reference is now made to FIG. 9, which is a screenshot of an exemplary VNPS prediction application presenting a heat-map highlighting cells which contribute for an exemplary detractors group, according to some embodiments of the present invention. A screenshot of an exemplary VNPS predictor such as the VNPS predictor 212 presents a heat-map that highlights cells the cell 238 that contribute high values of the KQI features counts that may cause and/or increase the size of a group of detractor cellular subscribers out of a population of cellular subscribers such as the cellular subscribers 252. The heat map presents cells 238 which contribute counts of the selected KQI to detractor cellular subscribers of the group, with a color scale that indicates their relative percent of contribution.

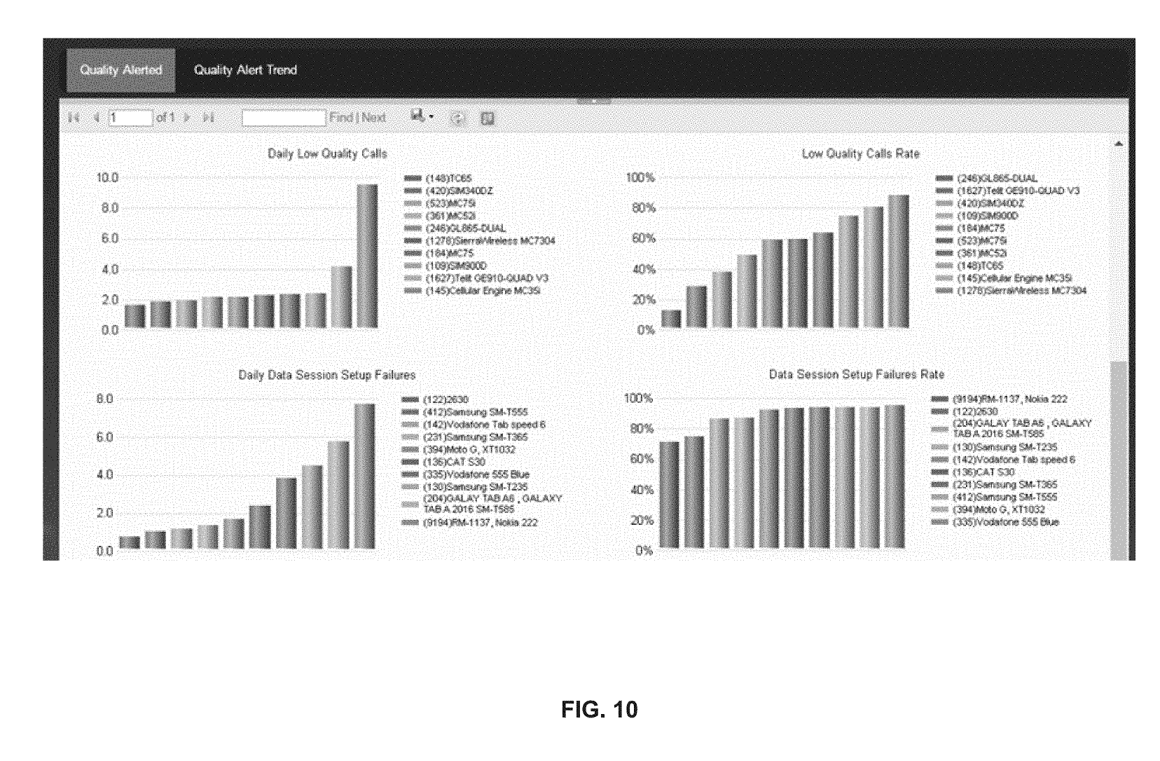

Reference is now made to FIG. 10, which is a screenshot of an exemplary VNPS prediction application presenting distribution of a cellular device model used by an exemplary detractors group, according to some embodiments of the present invention. A screenshot of an exemplary VNPS predictor such as the VNPS predictor 212 presents a heat-map that highlights cellular device models which are commonly used by detractor cellular subscribers of a detractor group and contributed high KQI features counts per detractor cellular subscriber per day. By default, this screenshot presents a detailed view of the top X device models who contribute the highest count or percent of the selected KQI feature(s) to detractor cellular subscribers of the group.

This set of device models be further fine-tuned by parameters such as distribution across the population of the detractors group, usage profile of the device mode and alike.

It is expected that during the life of a patent maturing from this application many relevant systems, methods and computer programs will be developed and the scope of the term KQI features is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer implemented method of predicting a rating score of a cellular service for a plurality of cellular subscribers, comprising:
obtaining at least one machine learning model trained with a plurality of feature vectors created for a subset of a plurality of cellular subscribers of a cellular operator participating in a survey to rate a cellular service provided by said cellular operator through a cellular network, each of the plurality of feature vectors is created by extracting a plurality of features of a respective cellular subscriber of said subset, said each feature vector is associated with a rating score assigned by said respective cellular subscriber;
predicting an estimated rating score of said cellular service for at least some of said plurality of cellular subscribers by applying said at least one machine learning model to said feature vector of extracted features of each of said at least some cellular subscribers; and
outputting said estimated rating score for each of said at least some cellular subscribers.

2. The computer implemented method of claim 1, wherein each of said plurality of cellular subscribers is a subscriber of said cellular operator and using at least one cellular device to connect to said cellular network.

3. The computer implemented method of claim 1, wherein said plurality of features comprises at least one of: at least one personal feature of said each cellular subscriber and at least one Key Quality Indicator (KQI) feature associated with said each cellular subscriber, said at least one KQI feature is indicative of a quality of a usage feature relating to said each cellular subscriber.

4. The computer implemented method of claim 3, wherein said at least one KQI feature is obtained by analyzing at least one operational record of said cellular network collected for said cellular service, said at least one operational record provides information relating to at least one of: a cellular usage detail, a cellular billing detail.

5. The computer implemented method of claim 3, wherein said at least one KQI feature is obtained by analyzing data transmitted over said cellular network using application specific KQI information provided by at least one Deep Packet Inspection (DPI) tool.

6. The computer implemented method of claim 1, further comprising normalizing at least one of said plurality of features to generalize said plurality of feature vectors.

7. The computer implemented method of claim 1, further comprising reducing at least one dimension of said each feature vector using a Linear Discriminant Analysis (LDA).

8. The computer implemented method of claim 1, wherein said rating score further includes a tag identifying a respective cellular subscribers as a promoter, a detractor or neutral.

9. The computer implemented method of claim 1, wherein said estimated rating score is associated with a prediction probability value.

10. The computer implemented method of claim 1, further comprising predicting said estimated rating score for said at least some cellular subscribers for a segment of said cellular service, said segment is a member of a group consisting of: a section of said cellular network, a certain geographical region, a certain geographical location, a certain segment of said at least some cellular subscribers, a certain type of said cellular service, and a certain cellular device type used by said at least some cellular subscribers.

11. The computer implemented method of claim 1, further comprising identifying a source cause of dissatisfaction for at least one detractor subscriber of said at least some cellular subscribers.

12. The computer implemented method of claim 1, further comprising normalizing said estimated rating score according to a confidence value provided by said at least one machine learning model to avoid a false positive detection.

13. The computer implemented method of claim 1, wherein said at least one machine learning model utilizes at least one statistical probabilistic Gaussian Mixture Model (GMM).

14. The computer implemented method of claim 1, further comprising said at least one machine learning model is trained with a plurality of another feature vectors created for at least one another subset of said plurality of cellular subscribers participating in at least one another survey.

15. The computer implemented method of claim 1, further comprising generating an alert in case an aggregated value of said estimated rating score computed for said at least some cellular subscribers exceeds a predefined threshold.

16. The computer implemented method of claim 1, further comprising analyzing said features and said estimated rating score of said at least some cellular subscribers to produce big data analytics to identify at least one rating pattern of said at least some cellular subscribers.

17. A system for predicting a rating score of a cellular product and/or service for a plurality of cellular subscribers, comprising:
at least one processor adapted to execute code, said code comprising:
code instructions to obtain at least one machine learning model trained with a plurality of feature vectors created for a subset of a plurality of cellular subscribers of a cellular operator participating in a survey to rate a cellular service provided by said cellular operator through a cellular network, each of the plurality of feature vectors is created by extracting a plurality of features of a respective cellular subscriber of said subset, said each feature vector is associated with a rating score assigned by said respective cellular subscriber;
code instructions to predict an estimated rating score of said cellular service for at least some of said plurality of cellular subscribers by applying said at least one machine learning model to said feature vector of extracted features of each of said at least some cellular subscribers; and
code instructions to output said estimated rating score for each of said at least some cellular subscribers.

18. A software program product for predicting a rating score of a cellular product and/or service for a plurality of cellular subscribers, comprising:
a non-transitory computer readable storage medium;
first program instructions for obtaining at least one machine learning model trained with a plurality of feature vectors created for a subset of a plurality of cellular subscribers of a cellular operator participating in a survey to rate a cellular service provided by said cellular operator through a cellular network, each of the plurality of feature vectors is created by extracting a plurality of features of a respective cellular subscriber of said subset, said each feature vector is associated with a rating score assigned by said respective cellular subscriber;
second program instructions for predicting an estimated rating score of said cellular service for at least some of said plurality of cellular subscribers by applying said at least one machine learning model to said feature vector of extracted features of each of said at least some cellular subscribers; and
third program instructions for outputting said estimated rating score for each of said at least some cellular subscribers;
wherein said first, second and third program instructions are executed by at least one processor from said non-transitory computer readable storage medium.
